(19) United States
(12) Patent Application Publication
(10) Pub. No.: US 2016/0255310 A1
(43) Pub. Date: Sep. 1, 2016

(54) SYSTEM FOR DATA COLLECTION AND DATA TRANSFER FROM A VEHICLE

(71) Applicant: Limited Liability Company "Radio Gigabit", Moscow (RU)

(72) Inventors: Mikhail Genrikovich MIN'KOVSKIY, Moscow (RU); Roman Olegovich MASLENNIKOV, Nizhniy Novgorod (RU); Grigoriy Konstantinovich NEMET, Brentwood, CA (US); Aleksey Gennad'evich SEVAST'YANOV, Moscow (RU); Vladimir Nikolaevich SSORIN, Nizniy Novgorod (RU); Aleksey Andreevich ARTEMENKO, Nizhniy Novgorod (RU)

(21) Appl. No.: 15/149,486

(22) Filed: May 9, 2016

Related U.S. Application Data
(63) Continuation-in-part of application No. PCT/RU2014/000851, filed on Nov. 10, 2014.

(30) Foreign Application Priority Data
Nov. 8, 2013 (RU) 2013149953

(51) Int. Cl. H04N 7/20; B61L 27/00; H04N 7/12; G08G 1/123; G07C 5/00; H04N 7/18

(52) U.S. Cl. CPC H04N 7/20; G07C 5/008; H04N 7/185; H04N 7/12; G08G 1/123; B61L 27/0077

(57) ABSTRACT

Disclosed is a system for data collection and data transfer from a vehicle, the system comprising at least one data collecting device provided in or on the vehicle, at least one data recording and storage device provided in or on the vehicle and connected to the at least one data collecting device, at least one first wireless communication device provided in or on the vehicle and connected to the at least one data recording and storage device, and at least one second wireless communication device located outside the vehicle, wherein the first and second wireless communication devices are capable of establishing a wireless connection therebetween providing high throughput for data reception and transmission, wherein the at least one first and the at least one second wireless communication devices each contain an antenna with a narrow radiation pattern beam.

### CROSS-REFERENCE TO RELATED APPLICATIONS

This application is a Continuation in part of International Patent Application No. PCT/RU2014/000851, filed Nov. 10, 2014, and claims priority of Application No. RU 2013149953, filed Nov. 8, 2013, all of which are incorporated by reference in their entireties. The International Application was published on May 14, 2015 as International Publication No. WO 2015/069151 A1.

### FIELD OF THE INVENTION

The present invention generally relates to the field of the systems for data collection and high throughput data transfer from a vehicle. More particularly this invention relates to the area of security enhancements by wireless communication suitable for the off load of video surveillance and telemetric data from passenger vehicles. Data refereed hereto is usually generated in very large volumes during the operation and use of transport vehicles. The invention is applicable for such transportation systems, as different types of passenger and cargo rails, trucks, subway trains, buses, aircrafts and in other types of transport vehicles.

### BACKGROUND ART

At present, more and more different systems for data collection inside transport vehicles and its transfer from the vehicles are being implemented. Transferring large data traffic outside trains, cars, aircrafts and other passenger and freight vehicles is one of the most demanding problems nowadays. Data generated during movement can include video surveillance data, telemetric data, other service, control and alarm information and general-purpose information. In many cases, volume of data traffic is so large that its transfer from a vehicle by means of existing methods and apparatuses is complicated, especially during a vehicle's movement. Consequently, one of the vital problems is in designing new wireless communication systems which are able to provide data off-loading with high throughput, i.e. to provide transferring of large data volume from a vehicle to a stationary data center (or to a server) for further processing and storage of the off-loaded data.

One of the most important applications for abovementioned systems of data collection and transfer from transport vehicles is public transportation security, which currently attracts high attention. That interest is caused by the large passenger traffic in modern megalopolis public transportation and, consequently, by increased danger of different illegal acts such as terrorist acts, thefts, robberies and so on. It is a very important task to create and increase effectiveness of surveillance systems, capable of tracking and monitoring situation inside transport vehicles throughout entire route including their stops. Video surveillance systems are the most common public transportation security systems, helping in prevention of illegal acts (including terrorism) as well as a way of fast detection of perpetrators. Public transportation video surveillance is also a good mean for restraining and deterrence.

Currently video surveillance systems are being planned and/or deployed on different types of transportation in many cities around the world, including suburban and long-distance railways, subway trains, buses, trams, trolley-buses, taxis and other public transportation systems. Technical requirements for modern surveillance systems are very high. For example, maximum observable area in every car of a train should be provided, which brings total number of cameras mounted in each car up to 6-8. Therefore, there is a need to provide aggregation and processing of large amount of data collected from all the cameras in a train and also to store this data on a hard drive. This typically requires expensive and bulky equipment, and creates challenges for mounting it inside a train.

The closest from technical point of view prior-art to the disclosed invention is the system of video surveillance, data storage and transferring from a train to the stationary operational center, that is disclosed in the patent U.S. Pat. No. 8,264,539. This system comprises of at least one high-speed data recording and storage device installed inside a transport vehicle, of at least one video recording device installed inside a transport vehicle and allowing observation of some part of the car's inner space, of first high data rate wireless communication device installed inside a vehicle and used for transferring the recorded and saved data, and of second high data rate wireless communication device mounted fixed at a station outside of a vehicle and used for reception of the recorded and saved data, wherein first and second wireless communication devices form a wireless communication connection for video surveillance data transfer when the train stops at a station. Herewith said wireless connection in particular can be implemented in millimeter-wave frequency range. Said system performs video surveillance data ranking based on its importance and transfers data from first to the second wireless device according to priority in descending order of its rank. The system disclosed in the U.S. Pat. No. 8,264,539 is shown in FIG. 1. It is apparent that this system can be easily adapted for transferring of other types of data generated throughout movement of the vehicle, such as, for example, telemetric data of different types (temperature, pressure and moisture monitoring of cargos, control data from different mechanisms of a train etc.).

In the examined prior-art system high-throughput data transferring is provided by close proximity of the first and second wireless communication devices only during train stops and also by utilizing wide bandwidth that is available in the millimeter-wave range. It is known that wireless millimeter-wave devices are able to provide high-throughput data transferring of up to few Gbps (for example, communication systems based on recently adopted IEEE 802.11ad standard operate in the 57-64 GHz frequency band and provides 1-6.8 Gbps on distances of few meters). Such high data transmission rates allow transferring of portions of collected data (including video surveillance data) over short time intervals during train stops.

However further increase of the video surveillance quality in transportation security systems and increase of the number of cameras in cars requires additional enhancement of a throughput of data channels between vehicles and stationary operational centers. The drawback of the prior-art system is that the data transfer is possible only during the stops at the stations. This limits transfer time interval and, correspondingly, the amount of data that can be transferred. Another drawback of the prior-art system is a need of a small distance (<10 m) between the first and second wireless communication devices during train stop. This limitation is caused by significant attenuation level of millimeter-wave signal in space. Therefore, the second communication device (installed at a station) must have vandal-proof housing since it is usually located in areas accessible for public. Another drawback of the examined system is high sensitivity to the interference. Thus, if some radiation source is placed near the system and radiates in the same frequency spectrum as the first and second wireless communication devices then said source will cause high interference level. In such case signal-to-interference-to-noise ratio will be decreased affecting data transfer rate.

Therefore, the objective of the present invention is to improve transmission throughput and, consequently, increase the data transferred volume outside a vehicle in a system of data collection and transfer. For example, in transportation video surveillance systems it improves security level by allowing increasing of video recording quality and video data processing and transmission rates. Another objective of the present invention is the ability to mount wireless communication devices in inaccessible places that enhances their reliability and eliminates the necessity of vandal-proof housings. Yet another objective of the disclosed invention is the decrease of the interference level when other radiating sources are located in close proximity to the system.

### SUMMARY OF THE INVENTION

The disclosed system for data collection and transfer from a transport vehicle is comprising at least one data collecting device provided in or on the vehicle, at least one data recording and storage device provided in or on the vehicle and connected to the at least one data collecting device, at least one first wireless communication device provided in or on the vehicle and connected to the least one data recording and storage device and at least one second wireless communication device located outside the vehicle, wherein the first and second wireless communication devices are capable of establishing a wireless connection therebetween providing high throughput for data reception and transmission.

In the disclosed system the at least one first and the at least one second wireless communication devices each contain an antenna with a narrow radiation pattern beam, wherein the antenna of the at least one second wireless communication device is directed substantially along the vehicle's path such that it illuminates by a narrow beam a portion of the vehicle's path, and wherein the antenna of the at least one first wireless communication device is directed such that it illuminates by its narrow beam the antenna of the at least one second wireless communication device when the vehicle is located within the said portion of the vehicle's path, the first and second wireless communication devices are capable of establishing a high throughput wireless connection while the vehicle is moving along the portion of the vehicle's path that is illuminated by the antenna beam of the at least one second wireless communication device, the first and second wireless communication devices establish the wireless connection in any millimeter-wave frequency band, and wherein beamwidths of the antennas of the first and second wireless communication devices are in the range from 1 to 5 degrees.

In the present invention, data collecting devices generate and/or collect homogeneous or heterogeneous types of data. These devices are physically located in or on a vehicle and can represent different sensors, video cameras, control or alarm equipment etc. In one embodiment of the invention the system for data collection and transfer is a video surveillance system and data collecting devices are video cameras which record video of inner space of a vehicle, thus providing video surveillance. Data recording and storage devices are connected to data collecting devices, that store data for a certain short period of time (for example, until the moment of data transfer to the operational center outside a vehicle). First wireless communication devices are installed inside or mounted on a vehicle and are connected to at least one data recording and storage devices and provide recorded data transfer outside a vehicle by means of wireless communication. Second wireless communication devices are installed stationary at vehicle stops or near them, and provide reception of recorded data from first wireless communication devices. In some embodiments of the invention transmission in the opposite direction, from second to first wireless communication device can be also provided.

In the disclosed invention use of the antennas with narrow radiation pattern beams increases the communication distance between the first and second wireless communication devices and provides stable radio connection. This advantage is ensured by the effect of space localization of the radiated power inside small angle range determined by the antenna beamwidth. As a result, high throughput wireless connection and data transmission are provided not only at vehicle stops (while devices are in close proximity) but also when the vehicle is approaching to a station and/or departing from it. Herewith maximal distance between first (mounted on the vehicle) and second (mounted stationary at the station) communication devices is determined by antenna gains and, thus, by its radiation pattern beamwidths. In realistic case, the distance between devices can be as long as 200-300 meters and even more.

It should be noted that usually a vehicle, arriving to stations, has low speed, thus approaching time of the last 200-300 meters before the stop is of a significant value in comparison to the vehicle stoppage duration. Therefore, the system disclosed in the invention provides up to several times greater amounts of data transfer in comparison to the prior-art system.

In addition, antennas with narrow radiation pattern beam and, respectively, with high gain value increase the received power level and the signal-to-noise ratio for the given distance. Consequently, data transmission throughput is also increased.

To provide the abovementioned advantages, antennas should be oriented in the predefined directions and have proper orientations relative to each other. According to that, orientation of a narrow antenna beam of each second wireless communication device should be substantially along the vehicle's path so that the beam illuminates a portion of this path, and a narrow beam of each first wireless communication device should be directed to illuminate the location of at least one antenna of second high throughput wireless communication device. This orientation should be valid while the vehicle is moving and making a stop within the illuminated area by the second wireless communication device's portion of a vehicle's path. The degree of beams overlap of the first and second devices can vary depending on specific requirements and geometry (typically from the maximum of −3 dB to −10 dB and less if the distance between wireless communication devices is short).

The additional advantage of the disclosed invention is the possibility to locate second wireless communication devices at inaccessible place, for example, on a tall post, a wall or inside the subway tunnel at some distance from the platform. That excludes the need for vandal-proof housings for second devices and thus decreases its cost.

Additionally, utilization of antennas with narrow radiation pattern beam situates radiation in a small angular space and thus, consequently, minimizes the interference level from neighboring devices of the same frequency range. This is also an advantage of the disclosed invention. All the considered advantages allow for increased data transfer throughput and the duration of the transmitting if compared with the prior art systems.

According to another embodiment of the present invention, the portion of the vehicle's path which is illuminated by the antenna beam of the at least one second wireless communication device contains the vehicle stopping position.

According to yet another embodiment of the present invention, the at least one first and second wireless communication devices are capable of maintaining a wireless high throughput connection while the vehicle is moving and making a stop within the portion of the vehicle's path that is illuminated by the antenna beam of the at least one second wireless communication device.

According to yet another embodiment of the present invention, the antenna of the at least one second wireless communication device is directed such that its beam is directed at an angle relative to the illuminated portion of the vehicle's path.

According to yet another embodiment of the present invention, the at least one second wireless communication device is firmly mounted on a mounting structure located in close proximity to the vehicle's path. Different type of posts, building walls and subway tunnel walls can be used as the mounting structure for the installation.

According to yet another embodiment of the present invention, the first and second wireless communication devices establish wireless connection in any in millimeter-wave frequency band in the range from 30 GHz to 150 GHz. The preferred frequency bands are 57-64 GHz, 71-76 GHz and 81-86 GHz, which are allocated for point-to-point communication systems and typically require only light licensing in many countries. Operation in the millimeter-wave range provides high data transmission rate up to few Gbps due to wide frequency bandwidths available in this part of the spectrum.

According to yet another embodiment of the present invention, wireless data transmission is performed substantially in one direction only from the at least one first wireless communication device to the at least one second wireless communication device. This provides maximum data rate for data offload.

According to yet another embodiment of the present invention, wireless connection between the first and second wireless communication devices is performed in duplex mode using time division duplexing. In such embodiment reverse transmission is allowed and can be used for service, control or alarm information transmitted from stationary center back to a vehicle. This information can also include general-purpose information (like Internet-traffic). In specific embodiments data transmission from first wireless communication device to second wireless communication device can be allocated to more than 80% of the connection time, while the remaining time slots are used for the reverse direction.

According to yet another embodiment of the present invention, wireless connection between the first and second wireless communication devices is performed in duplex mode using frequency division duplexing. In this embodiment large data traffic can be sent from and to a vehicle simultaneously.

According to the present invention, beamwidths of the antennas of the first and second devices are in the range from 1 to 5 degrees. Said range is often optimal because smaller beamwidths lead to difficulties in the antenna alignment and to possible connection interruptions during vehicle movement due to its swings and sways relative to the static coordinate system. At the same time, larger beamwidth values can lead to insufficient gain level and decrease of communication distance and also to multipath propagation effect in the communication channel due to possible reflections from closest objects (it is especially actual for subway tunnels where interference environment is a significant limiting factor). It should be mentioned that beamwidths of first and second wireless communication devices can be either equal or not equal to each other. For example, in one embodiment the beamwidth of the antenna mounted on a vehicle or installed inside it can be increased comparing to the beamwidth of the antenna which is mounted stationary at the station. This is needed to reduce influence of vehicle's sways during the movement.

In one of the embodiments the disclosed system for data collection and transfer is intended for operation with a train, wherein the at least one first wireless communication device is installed in head and/or rear cars of the train. Installation of the first wireless communication device in a head car implies that its antenna is directed along the train route direction to second wireless communication device in such manner that stable wireless connection is established during the train arriving and making a stop at the station. Installation of the first wireless communication device in a rear car implies that its antenna is oriented opposite to the train route direction towards second wireless communication device antenna in such manner that stable wireless connection is established during the train making a stop and arriving to the station. When first wireless communication devices are installed both in head and rear cars then stable wireless connection is established during the train making a stop at the station and also arriving and departing from the station.

In one specific embodiment, the narrow-beam antenna of the at least one first wireless communication device is mounted on the outside of the train's car. In another specific embodiment, the narrow-beam antenna of at least one first wireless communication device is mounted inside a driver's cabin of the train.

In yet another specific embodiment the at least one data collecting device is a video recording device installed so to observe some part of the vehicle's inner space. In this embodiment case data collecting system is a video surveillance system for a vehicle. According to yet another specific embodiment of the disclosed system, the at least one video recording device is additionally connected to monitors located inside the vehicle. Such realization provides ability to monitor video surveillance data (for example, in driver's cabin) within the vehicle in real time and allows possibility of operative decisions in case of illegal acts or threads during train movement.

In yet another specific embodiment the disclosed system is intended for operation with subway trains, wherein the at least one second wireless communication device is mounted stationary on the subway tunnel on a wall. The distance between location of the second device antenna and location of the first device antenna (installed in a head or a rear car) during train stops can reach 10-30 meters. This ensures stable wireless connection for high throughput data transmission.

In another specific embodiment, the disclosed system is intended for operation with an automotive vehicle and the narrow-beam antenna of the at least one first wireless communication device is installed inside the vehicle or mounted on the outside of the vehicle.

According to yet another embodiment of the present invention, the data collecting and transferring system is intended for the operation with an aircraft, and the narrow-beam antenna of at least one first wireless communication device is installed inside the aircraft's cabin or mounted outside on the aircraft's airframe.

According to yet another embodiment of the present invention, the designed system is intended for operation with a container truck, and the at least one data collecting device is installed inside the containers and the at least one first wireless communication device is mounted on the container truck. In this embodiment the data collecting devices can represent sensors which collect information about cargo properties and conditions during transportation. More particularly, the vehicle can be a freight truck, barge, ship, aircraft etc.

According to yet another embodiment of the disclosed invention the at least one second wireless communication device is connected by high capacity optical or radio channel to a server for recording, storage and processing of transmitted data. This allows for longtime data storage on a remote server for data review and processing. All second devices can be connected to each other by means of wire or optical high capacity network or connected to the global network for data transmission.

According to yet another embodiment of the disclosed invention the at least one first wireless communication device transmits a predetermined test signal periodically when the vehicle is moving, and the at least one second wireless communication device generates a response test signal after receiving the test signal from the at least one first wireless communication device or the at least one second wireless communication device transmits a predetermined test signal periodically, and the at least one first wireless communication device generates a response test signal after receiving the test signal from the at least one second wireless communication device, wherein the at least one first wireless communication device starts data transmission after receiving the response test signal from the at least one second wireless communication device or after transmitting the response test signal to the at least one second wireless communication device.

Wherein the antenna of the at least one second wireless communication device is directed such that it illuminates by a narrow beam a portion of the vehicle's path, and wherein the antenna of the at least one first wireless communication device is directed such that it illuminates by its narrow beam the antenna of the at least one second wireless communication device when the vehicle is located within the said portion of the vehicle's path. Technical result of the disclosed system is in increase of data rate and data traffic that can be offloaded from a vehicle by providing millimeter-wave wireless connection during vehicle stops and movement. The present invention is intended for use in railway passenger and freight transports, subway trains and subway stations, buses, aircrafts, and other types of transportation.

Further features and advantages of the present invention will become apparent from the descriptions of subsequent preferred embodiments with reference to accompanying drawings. Similar elements in the drawings are denoted by similar reference numerals.

### BRIEF DESCRIPTION OF THE DRAWINGS

FIG. 1 shows a video surveillance and data transferring system from a train to a stationary operational center known from the U.S. Pat. No. 8,264,539 (prior art).

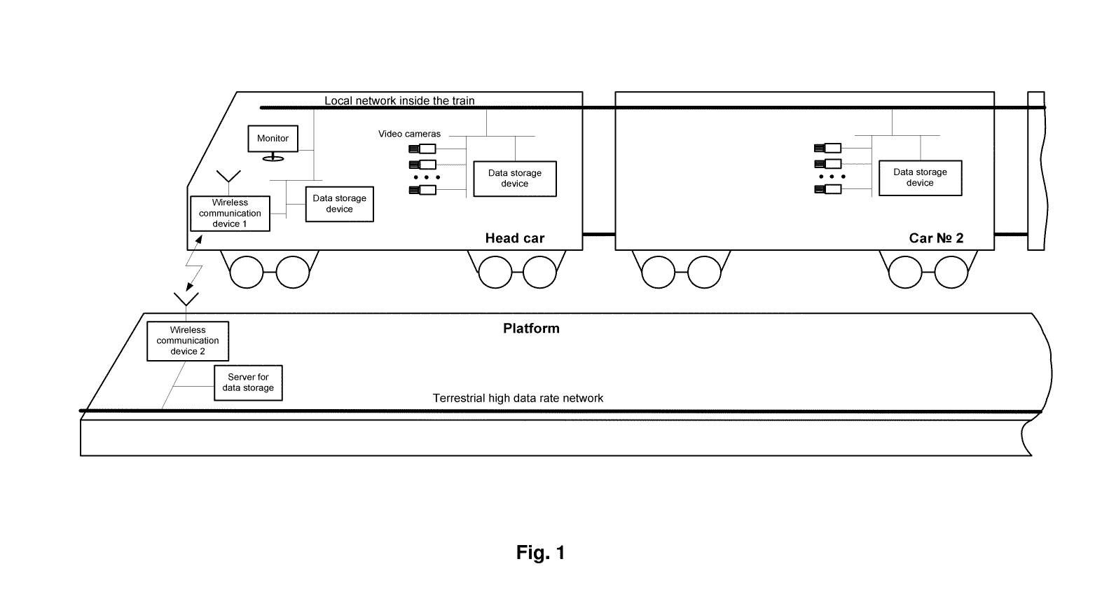

FIG. 2 shows an example of a system for video surveillance data collection and data transfer from a train in accordance with the present invention in which a first wireless communication device is located in the train's head car.

FIG. 3 presents an example of a system for video surveillance data collection for a subway train and data transmission from the train in accordance with the present invention in which a second wireless communication device is mounted stationary near the station inside the subway tunnel.

FIG. 4 shows an example of a system for video surveillance in a train and data transmission from the train in accordance with the present invention in which first wireless communication devices are located in the train's head and rear cars.

FIG. 5 shows an example of a system for video surveillance in a train and data transmission from the train in accordance with the present invention in which first wireless communication devices and their antennas are located on top of the train cars.

FIG. 6 presents an example of a system for data collection and data transfer from an automotive vehicle in accordance with the present invention in which first wireless communication device and its antenna are mounted on top of the vehicle's cabin.

### DETAILED DESCRIPTION OF THE INVENTION

The designed system for data collection and data transfer from a vehicle solves the problem of increasing transmission data-rate and the amount of data transferred outside a vehicle. For example, in video surveillance systems for vehicles it serves to enhance safety level by using high quality video cameras and the ability to process the video data promptly. Additionally it enhances the reliability of data transfer and does not require vandal-proof housings of the wireless communication devices. The decrease of the interference level when other radiating sources are located in close proximity to the system is also provided.

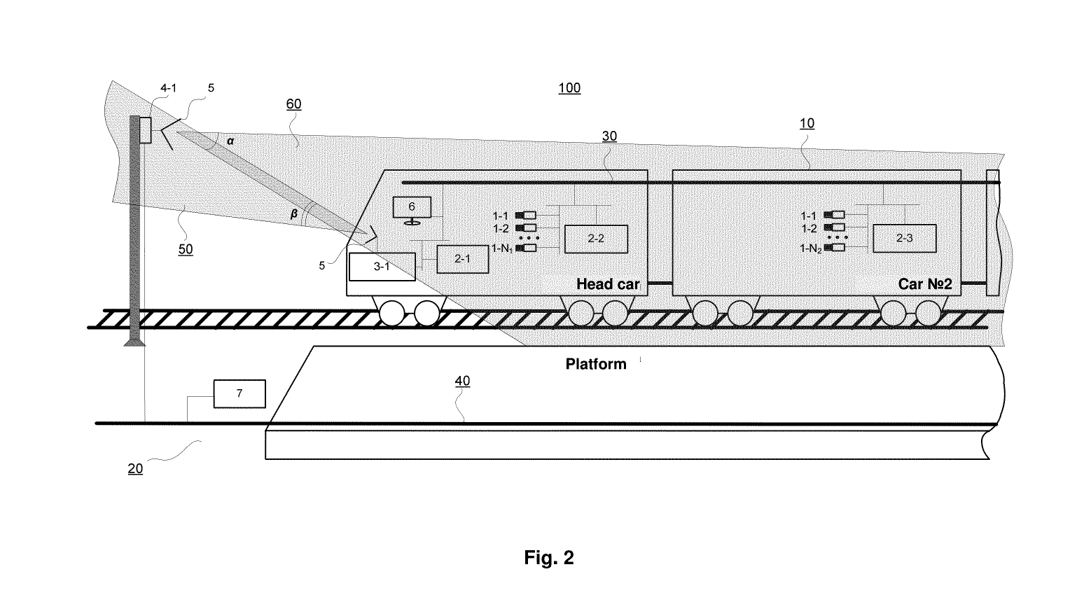

The example of the system 100 for data collection and data transfer in accordance with the present invention is shown in FIG. 2. The system 100 is a video surveillance system for a vehicle 10 which comprises data collecting devices 1-1, 1-2, . . . , 1-N (in the shown embodiment video cameras) installed inside the vehicle 10, data recording and storage devices 2-1, 2-2, . . . , 2-M installed inside the vehicle 10 and connected to data collecting devices 1-1, 1-2, . . . , 1-N, a first wireless communication device 3-1 mounted on the vehicle 10 and connected to the data recording and storage devices 2-1, 2-2, . . . , 2-M, and a second wireless communication device 4-1 installed stationary at the station 20 (or close to it) where the vehicle 10 makes its stops. Devices 3-1 and 4-1 include antennas 5 with a narrow radiation pattern beam. A narrow beam of the second wireless communication device 4-1 is directed substantially along a path of the vehicle 10 and illuminates a portion of this path, and a narrow beam of the first wireless communication device 3-1 is directed in such manner that it illuminates the antenna of the second wireless communication device while the vehicle is moving and making a stop within said illuminated portion of the vehicle's path. It should be noted that in other realizations the system for data collection and data transfer can comprise more than one first and/or second wireless communication devices. In that case a narrow beam of each of the second wireless communication device is directed along the vehicle's path and illuminates a portion of this path, and a narrow beam of each of the first wireless communication device is directed in such manner that it illuminates the antenna of at least one of the second wireless communication devices while the vehicle is moving and making a stop within said illuminated portion of the path.

In the described example the video surveillance system is used for operation with a train comprising multiple cars, all the cameras 1-1, 1-2, . . . , 1-N are connected to the devices 2-1, 2-2, . . . , 2-M by local high-speed wire or a wireless network 30 for data recording and storage. In their turn, the devices 2-1, 2-2, . . . , 2-M are connected to the wireless communication device 3-1 purposed for transferring the recorded video data from the vehicle 10. The local network 30 connects all devices 1-1, 1-2, . . . , 1-N and 2-1, 2-2, . . . , 2-M located in all train cars and can comprise of additional nodes of routers, switches and hubs if it is necessary. Additionally, to provide an ability of immediate response in case of threads and dangers, all data collecting devices 1-1, 1-2, . . . , 1-N and data storing devices 2-1, 2-2, . . . , 2-M are connected to the monitors 6 (by means of the local network 30) which are located inside the train for the real-time monitoring of video surveillance data from different cameras. These monitors can be located, for example, in the driver's cabin, the conductor compartments or in the compartments of transport police.

The device 4-1, and all other similar devices along the train's route, are mounted stationary at all the stops and are connected to the high-speed local network 40 in such manner that video data can be transmitted to the remote operational center to be viewed and processed on the server 7. This network 40 between the stations can be implemented as a high throughput wired or fiber communication network.

In the disclosed system of data collecting and data transferring from a vehicle, both antennas 5 of wireless communication devices 3-1 and 4-1 are directed so that their angle coverage areas 50 and 60 overlap each other at some level, that in one example cannot be below −3 dB of the antenna radiation pattern beams during all the time the train approaching the station. Hence, It provides stable connection during the period covering the vehicle 10 approach to a platform, as well as its stop. In addition this solves the problem of increasing the duration of transmission sessions and, thus, the amount of transmitted data. For instance, the data throughput of 1-10 Gbit/s and more can be provided at the distances as large as of 100-300 m. Consequently, duration of data transfer can be increase by more than a minute (while approaching the station) comparing with only 30-40 sec. stop duration. Thus, even with the same data throughput the total transferred data volume can be increased by 100-200%.

Specific positioning of the antenna beams are to be selected based on the geometry considerations. For example, if the device 4-1 is located on an elevated structure (for example, on a post with the height of 3-10 m located near—<2 m—the train track), the antenna should be tilted slightly downward (about 1-5 degrees) from the horizontal plane in such manner that it covers the train head car stop point (where the antenna of the device 3-1 is located) and some part of the train path during its approach to the station. The antenna of the device 3-1 installed on the train should be pointed slightly higher (again 1-5 degrees) than the horizontal plane in such manner that the line between the antennas of the devices 3-1 and 4-1 is included into the area 50 that covers the path train approaching the station from large distance of several hundreds meters, and the point of the train stop. During the stop the distance between first and second wireless communication devices can be in the range 10-50 m.

According to one embodiment of the invention, the devices 3-1 and 4-1 are wireless communication devices operating in millimeter-waves frequency range. Utilization of antennas with narrow radiation pattern beam of 1-5 degrees (and, thus, with high gain of >20-30 dBis) enhances data transmission rate by increasing the received power level and the signal-to-noise ratio. Frequency band for data transmission in this case can be within the range of 30-150 GHz. In some specific embodiments, the 57-64 GHz band is preferable since it does not require licensing of each communication device. Similarly, the use of radio relay system in the 71-76 GHz and 81-86 GHz bands, that mostly requires just simplified licensing is also preferable for this invention.

Narrow-beam millimeter-wave antennas are more compact in comparison to lower frequency antennas with large apertures for the same gain level. For example consider traditional frequency ranges of <6 GHz (in particular Wi-Fi systems) which are also used for communication with trains and other vehicles. Such systems have data throughput not greater than 100 Mbit/s and they are quite sensitive to interference environment (especially in metro tunnels). In order to have a narrow beam of 1-5 degrees, antenna have to be (even in theory) electrically large: of the order of 10-40 of free space wavelengths. This fact prohibits practically the use of low band antennas for the disclosed system. For instance antenna operating in a popular 2.5 GHz band should have the size of −1.5-5 m. It is not effective to install such antenna on top of the train car or in a tunnel near the track. In contrast going to the millimeter-wave range (60 GHz, for example) will lead to antenna diameters of 6-25 cm only that is quite small. Oppositely the antenna of such size but of 2.5 GHz frequency will provide only about 10-14 dBi gain that is lower than 30 dBi provided by the antenna in the disclosed millimeter-wave system.

In some specific embodiments, antennas 5 of devices 3-1 and 4-1 can be represented by Cassegrain antennas, lens antennas, antenna arrays or some other types of aperture antennas.

In some cases, in addition to forward transmission from vehicle to the station, the reverse communication is also required. Such reverse information coming to the vehicle can be the signaling or warning of emergency situations, or with instructions to a crew. Also this can be a service data related to a situation inside the vehicle or outside it, that can allow for a rapid response by the crew. In such cases in accordance with the present invention, the devices 3-1 and 4-1 can employ time division duplex wireless data transmission (from a vehicle or to it). Further, two directions of transmission can be not equal in terms of throughput. Forward direction (from a train to a land) can occupy up to 90% of time and backward only 10%. According to another disclosed embodiment, frequency division duplexing scheme can be used for transmission.

Beamwidths and respective coverage areas of the antennas 5 of the devices 3-1 and 4-1 do not need necessarily to be equal. This must be defined by the antennas positioning arrangement and by the shape and length of the train paths near the station. Correspondingly, this applies certain different requirements to antenna gains necessary for reliable communication. In one of the preferred embodiments, beamwidth of each antenna is in the range of 1-5 degrees. And, for instance, the antenna of a stationary station can have the beamwidth of 1-3 degrees and the antenna on a train—of 3-5 degrees. In some examples, the beam can be made unsymmetrical to maximize intensity in the direction of train's arrival path (when the distance between wireless devices is comparably big), and to provide smaller, but still sufficient intensity for reliable communication for stops, when distance is smaller.

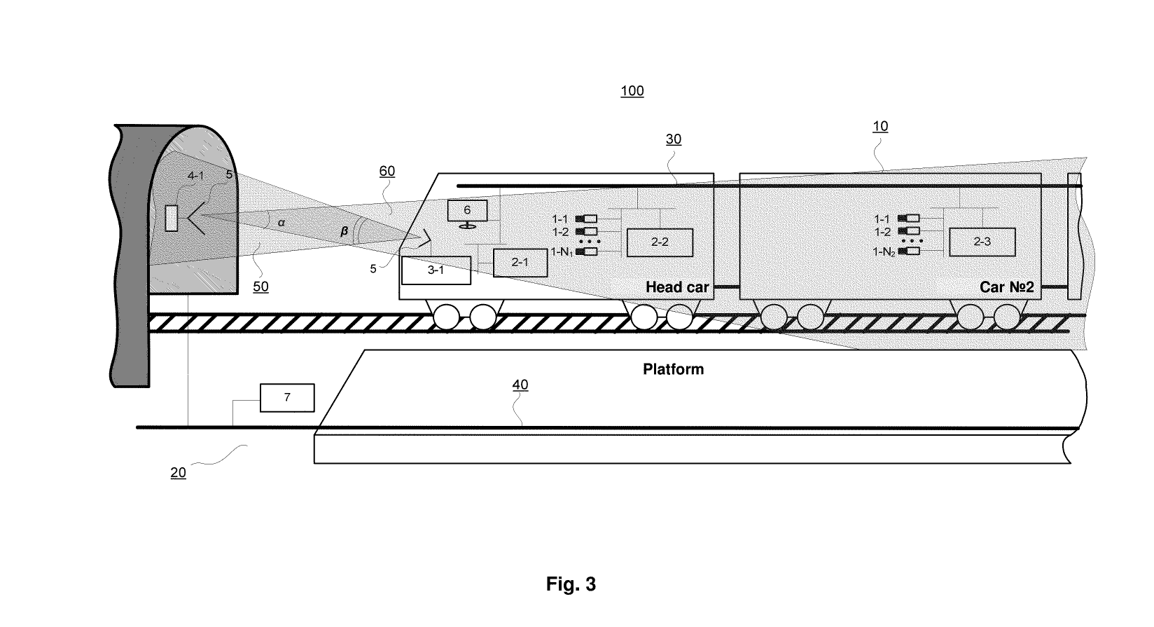

In yet another embodiment, a vehicle represents a subway train and the wireless communication device 4-1 is installed stationary inside a subway tunnel on its side wall as shown in FIG. 3. Herewith the distance between antennas of the devices 3-1 and 4-1 is 10-30 meters. When the device 4-1 and its antenna are installed inside the subway tunnel, there is no free access to people (except service personnel) to the transmission device, thus there is no demand for vandal-proof housing for the device 4-1 and the risk of device disablement due to human factor is reduced.

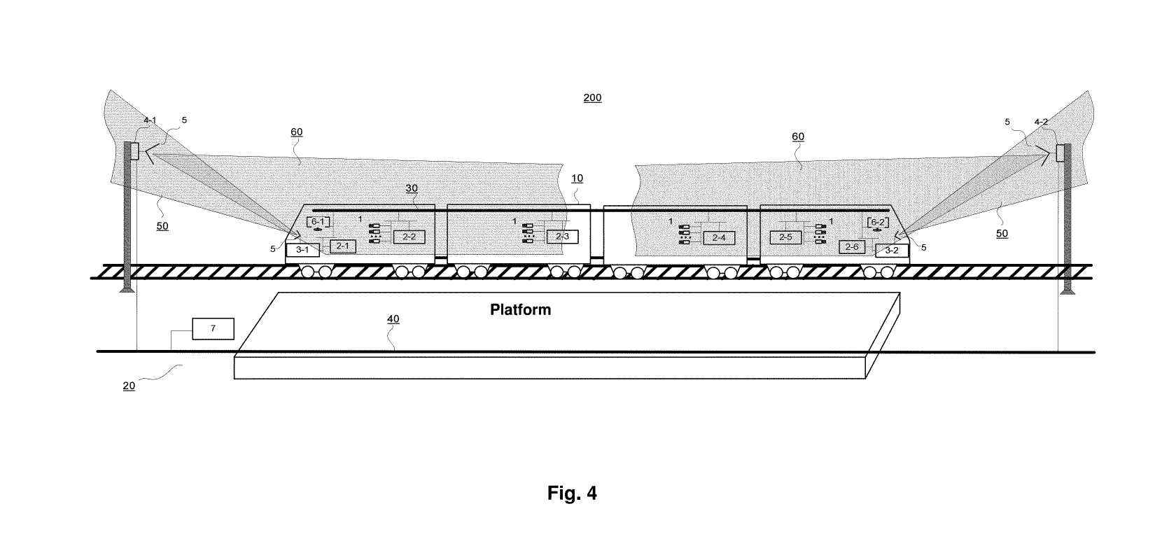

In another embodiment wireless the communication device 3-2 is mounted in the train's rear car that also hosts driver's cabin (like in subway trains). In this case all the advantages mentioned above are provided when the antenna of the stationary device 4-2 is installed so to provide coverage area which includes stop point of the train rear car and some portion of the train path when it leaves the station. In another specific embodiment of the designed system 200 presented in FIG. 4 installation of the devices 3-1 and 3-2 in both head and rear cars provides the increase of the received data amount due to the increase of connection time interval which includes maximum portion of a train path when it arrives, makes a stop and leaves the station.

In embodiments shown in FIGS. 2, 3 and 4 the devices 3-1 and 3-2 and their antennas are located in the driver's cabin. This is possible because millimeter-waves propagate through glass media without significant losses. Installation of the devices 3-1 and 3-2 inside a train does not require any special approval procedures.

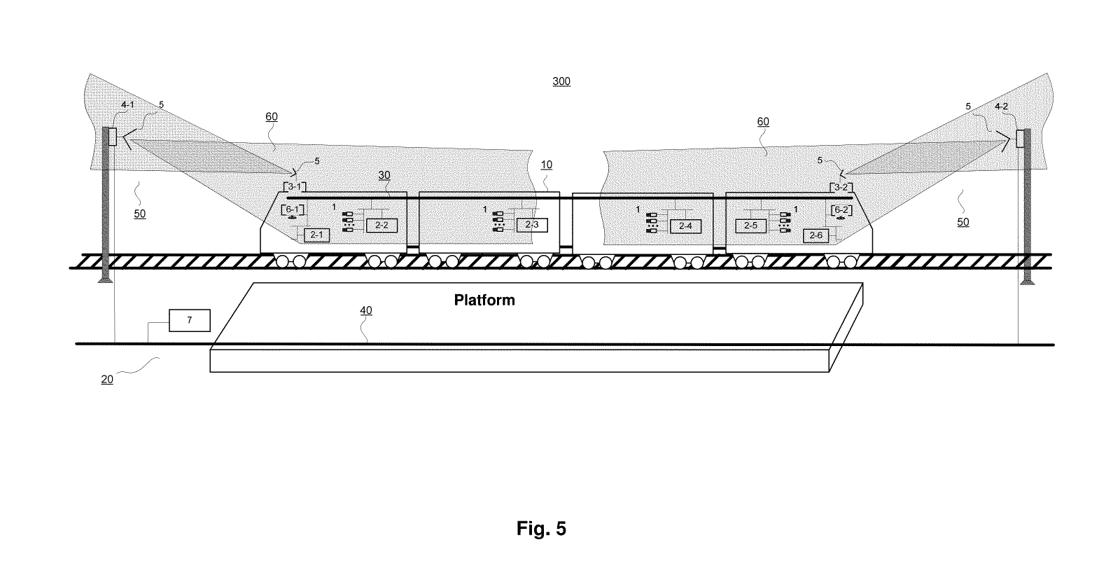

In another specific embodiment the system 300 for data collecting and data transferring from a vehicle is shown in FIG. 5, the wireless communication devices 3-1 and 3-2 and their antennas 5 are mounted on the rooftop of a train car. This is an inaccessible location that minimizes risks of the device being disabled due to human factor. In this realization, the devices 3-1 and 3-2 and their antennas 5 can be mounted on any train car. Herewith the antenna 5 of the device 3-1 should be oriented along the train forward direction while the antenna 5 of the device 3-2 should be oriented in opposite direction.

In another specific embodiment of the invention, a vehicle is an automotive vehicle and the narrow-beam antenna 5 of the wireless communication device 3-1 is mounted inside the vehicle or mounted externally on its frame. The wireless communication device 4-1 in this case is mounted on a construction (for example, post, building wall etc.) which height is preferably higher than the vehicle height and such construction is located close (<1-2 m) to the vehicle's path in order to provide required coverage area when the transport vehicle is arriving at the stop. The structure with the mounted device 4-1 is located in close proximity (5-15 m) to the vehicle's stop location. The device 4-1 in this case is connected to the landline high-speed network.

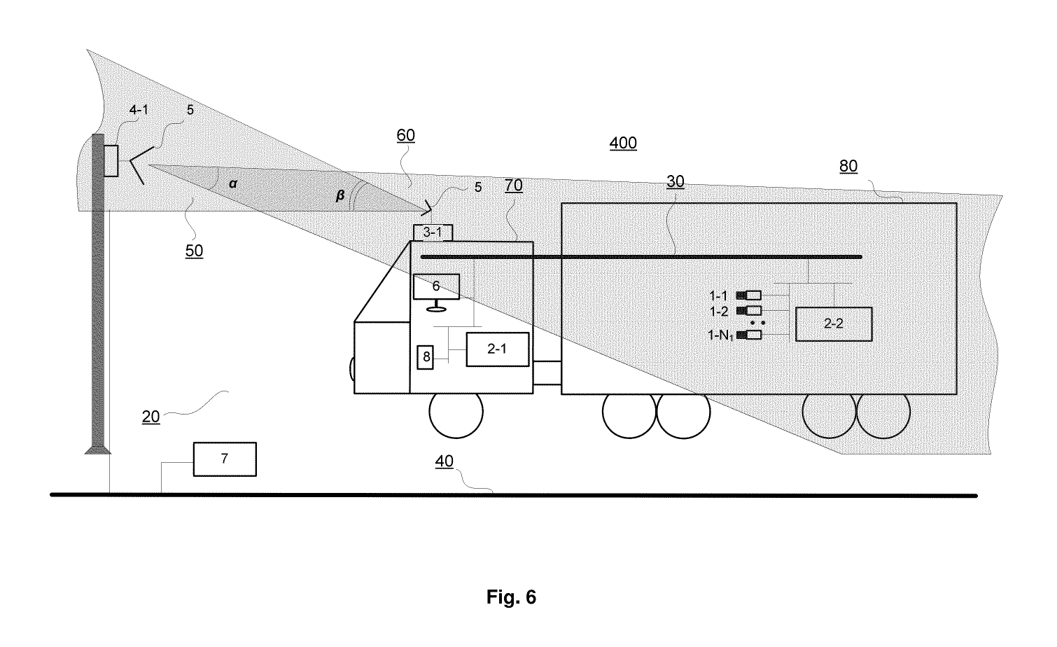

In some specific embodiments, an automotive vehicle is a passenger bus with video surveillance being performed with prompt data transmission to the stationary operational center or to the server for data processing and storage. In another embodiment, an automotive vehicle can be a cargo truck, in which transmission of telemetric and other types of data to the information collecting center is performed. The system 400, that is designed according to such embodiment, is for data collection and data transfer from an automotive vehicle. It is presented in FIG. 6. An automotive vehicle comprising a cabin 70 and a trailer 80 equipped with the system according with the present invention performs telemetric data transmission from the data collecting devices 1-1, 1-2, . . . , 1-N. This data is generated en route to a station 20 which has the stationary wireless communication device 4-1. The wireless communication device 3-1 in this embodiment is mounted on a roof of a cabin 70. The data recording and storage devices 2-1, 2-2, . . . , 2-M are located in different parts of the vehicle. In this example data transmission can be provided in both directions. Data transmitted to a vehicle can include service information and also generally-purposed information for the personnel and vehicle passengers. Herewith passenger and user devices can be connected to wire or wireless local network 30 deployed in the vehicle for transmission and reception of general purpose data (for example Internet traffic) by using of the connection between the devices 3-1 and 4-1.

In another embodiment of the disclosed system for data collecting and transmission, the vehicle is an aircraft and a narrow-beam antenna of the at least one first wireless high data rate device is installed inside the aircraft's cabin or mounted on its fuselage. Herewith wireless connection can be provided during aircraft movement to the terminal gate of the airport and during its stop. This allows transferring quite promptly large data traffic like aircraft flight telemetric data, black box data in case of some emergency situation during the flight, video surveillance data and passenger cabin entertainment (including video).

In another specific embodiment, the vehicle is purposed for cargo container transportation and data collecting devices are installed inside the containers. The first wireless communication devices in this case are mounted on the vehicle. In such embodiment the data collecting devices collect data on cargo properties and conditions inside the containers. The vehicle in other embodiments can be represented by a truck, a barge, an aircraft etc. The transmission of collected during the transportation data can be provided at any station having second wireless communication devices deployed.

Data collection and data transferring system shown in FIG. 2 operates as follows. In the vehicle 10 being en route between stop stations, the devices 1-1, 1-2, . . . , 1-N installed inside the vehicle generate and collect data. This data is recorded by the devices 2-1, 2-2, . . . , 2-M which are connected to the devices 1-1, 1-2, . . . , 1-N by means of the local high data rate wire or wireless communication network. Data is also transmitted to the monitors 6 and can be displayed in real time. The monitors 6 can be located in different service rooms of the vehicle 10. When the vehicle arrives to the station 20 the wireless communication device 3-1, which is located on a vehicle 10, connects to the wireless communication device 4-1 that is mounted stationary at the station 20. After connection is established, data is transmitted by means of wireless radio channel from the device 3-1 connected to the devices 2-1, 2-2, . . . , 2-M to the device 4-1. Simultaneously transmission of service or another type of data can be initiated from the station 20 to the vehicle 10. Wireless connection is established and maintained throughout all time during the vehicle 10 arrival to the station 20, stop and departure from the station 20. This connection is provided by the narrow-beam antennas 5 of the devices 3-1, 3-2 and 4-1, 4-2. Therefore, the duration of the connection is defined essentially by the sum of time intervals during which the vehicle and the devices 3-1 and 3-2 are within the antenna coverage area 60. Video surveillance data received by each device 4-1 and 4-2 is transmitted by means of the landline high data rate network 40 which transmits data to the server 7 for further data storage and processing.

Different approaches for providing connection and data transmission in the disclosed invention can be provided by different ways. In one of the examples data collected during the vehicle movement between the stations can be transmitted in the sequence and order of its generation or storage. In other examples data can be prioritized according to different criteria. For example, sensor or telemetric data can have the highest priority, while data generated by different video cameras can have secondary priority and so on. Also priority can be assigned by different algorithms or protocols that can detect and classify suspicious or dangerous situations (e.g. with the help of video processing or images recognition).

Also in some examples, different approaches for initiation and for disconnect between first and second wireless communication devices can be used. In the simplest case it can be provided manually by the crew member In other examples, algorithms for automatic detection of possible connection can be used. In particular, in one of the embodiments of the designed system the following approach for data collecting can be utilized. During the vehicle movement between two stations, first wireless communication device transmits certain test signal periodically with short time intervals in between. Any second device after receiving such signal generates response signal, and after reception of this test signal the first devices start data transmission with required confirmation that every information block was successfully received by second wireless communication device. In the absence of such acknowledgment, current information block is considered as non-transmitted, and first device switches back to test signal sequencing mode. In another realization test signal can be transmitted by second wireless communication device.

The system for data collection and wireless data transfer from a vehicle in the examined examples provides the increase of the transmission rate and data traffic. For example in video surveillance system for vehicles this improves security by providing video data with better quality and the possibility to rapidly process this video data. In addition, the disclosed invention solves the problem of the inaccessible location for radio communication devices mounted near the station that increases reliability of the designed data collecting and data transferring system. Moreover, the invention is purposed for decreasing the interference level from third-party sources located close to communication devices of the system.

The present invention is not limited to specific embodiments, which are described in the present disclosure solely as an illustrative examples; the invention encompasses all modifications and variations without departing from the spirit and scope of the invention set forth in the accompanying claims.

1. A system for data collection and data transfer from a vehicle, the system comprising:
at least one data collecting device provided in or on the vehicle,
at least one data recording and storage device provided in or on the vehicle and connected to the at least one data collecting device,
at least one first wireless communication device provided in or on the vehicle and connected to the at least one data recording and storage device, and
at least one second wireless communication device located outside the vehicle, wherein the first and second wireless communication devices are capable of establishing a wireless connection therebetween providing high throughput data reception and transmission,
wherein
the at least one first and the at least one second wireless communication devices each contain an antenna with a narrow radiation pattern beam,
the antenna of the at least one second wireless communication device is directed substantially along the vehicle's path such that it illuminates by a narrow beam a portion of the vehicle's path,
the antenna of the at least one first wireless communication device is directed such that it illuminates by its narrow beam the antenna of the at least one second wireless communication device when the vehicle is located within said portion of the vehicle's path,
the first and second wireless communication devices are capable of establishing a high throughput wireless connection while the vehicle is moving along the portion of the vehicle's path that is illuminated by the antenna beam of the at least one second wireless communication device,
the first and second wireless communication devices establish the wireless connection in any millimeter-wave frequency band, and
wherein beamwidths of the antennas of the first and second wireless communication devices are in the range from 1 to 5 degrees.

2. The system according to claim 1, wherein the portion of the vehicle's path which is illuminated by the antenna beam of the at least one second wireless communication device contains the vehicle stopping position.

3. The system according to claim 2, wherein the at least one first and second wireless communication devices are capable of maintaining the wireless high throughput connection while the vehicle is moving and making a stop within the portion of the vehicle's path that is illuminated by the antenna beam of the at least one second wireless communication device.

4. The system according to claim 1, wherein the antenna of the at least one second wireless communication device is directed such that its beam is directed at an angle relative to the illuminated portion of the vehicle's path.

5. The system according to claim 1, wherein the at least one second wireless communication device is firmly mounted on a mounting structure located in close proximity to the vehicle's path.

6. The system according to claim 1, wherein the first and second wireless communication devices establish the wireless connection in any millimeter-wave frequency band in the range from 30 GHz to 150 GHz.

7. The system according to claim 1, wherein data is transmitted wirelessly substantially in one direction only from the at least one first wireless communication device to the at least one second wireless communication device.

8. The system according to claim 1, wherein the wireless connection between the first and second wireless communication devices is performed in a duplex mode using time division duplexing.

9. The system according to claim 1, wherein the wireless connection between the first and second wireless communication devices is performed in a duplex mode using frequency division duplexing.

10. The system according to claim 1, wherein the antenna beam of the at least one first or second wireless communication device has unsymmetrical shape.

11. The system according to claim 1, wherein the beamwidth of the antenna of the at least one first wireless communication device is wider than the beamwidth of the antenna of the at least one second wireless communication device.

12. The system according to claim 1 for operation with a train, wherein the at least one first wireless communication device is installed in a head car and/or a rear car of the train.

13. The system according to claim 12, wherein the narrow-beam antenna of the at least one first wireless communication device is mounted outside of the train's car or inside a driver's cabin.

14. The system according to claim 12, wherein
the train is a subway train which paths are at least partly located in a subway tunnel,
wherein the at least one second wireless communication device is a high-speed communication device and
the antenna of the at least one second wireless communication device is mounted stationary on a wall of the subway tunnel.

15. The system according to claim 1, wherein the at least one data collecting device is a video recording device installed to observe a part of the vehicle's inner space.

16. The system according to claim 1 for operation with an automotive vehicle, wherein the narrow-beam antenna of the at least one first wireless communication device is installed inside the vehicle or mounted on the vehicle.

17. The system according to claim 1 for operation with an aircraft, wherein the narrow-beam antenna of the at least one first wireless communication device is installed inside the aircraft's cabin or mounted outside on the aircraft's airframe.

18. The system according to claim 1 for operation with a container truck, wherein the at least one data collecting devices is installed inside containers of the container truck, and the at least one first wireless communication device is mounted on the container truck.

19. The system according to claim 1, wherein the at least one second wireless communication device is connected through a high capacity optical or radio channel to a server for recording, storage and processing transmitted data.

20. The system according to claim 1, wherein
the at least one first wireless communication device transmits a predetermined test signal periodically when the vehicle is moving, and
the at least one second wireless communication device generates a response test signal after receiving the test signal from the at least one first wireless communication device or
the at least one second wireless communication device transmits a predetermined test signal periodically, and
the at least one first wireless communication device generates a response test signal after receiving the test signal from the at least one second wireless communication device, wherein
the at least one first wireless communication device starts data transmission after receiving the response test signal from the at least one second wireless communication device or after transmitting the response test signal to the at least one second wireless communication device.
